(19) United States
(12) Patent Application Publication
(10) Pub. No.: US 2006/0188040 A1
(43) Pub. Date: Aug. 24, 2006

(54) Data channel with sampling rate less than the channel bit rate

(75) Inventor: Marvin Vis, Boulder, CO (US)

Correspondence Address: LAW OFFICE OF DAN SHIFRIN, PC - CIRRUS LOGIC, 14081 WEST 59TH AVENUE, ARVADA, CO, 80004, US

(73) Assignee: Cirrus Logic, Incorporated, Austin, TX (US)

(21) Appl. No.: 11/063,043

(22) Filed: Feb. 22, 2005

(51) Int. Cl. H04L 27/06

(52) U.S. Cl. 375/340

(57) ABSTRACT

Due to code constraints and pickup limitations of optical pickups, much of the signal energy of a binary coded analog signal, and therefore much of the information content, has dissipated at frequencies above about one-half (or even above about one-fourth) of the sampling frequency fₛ. For example, the response of data streams from DVD layers falls off by about 40 dB by fₛ/4 while the response of a CD data stream falls off by about 18 dB by fₛ/4. Thus, a data channel is provided in which the sampling rate fₛ is less than the channel bit rate f_{b}. The data channel may be part of an optical storage drive in which data has been RLL encoded at d≧0 and the sampling rate may be one-half the channel bit rate. Preferably, a sequence detector is employed which outputs two channel bits for each input sample.

### TECHNICAL FIELD

The present invention relates generally to processing data in a data channel and, in particular, to a channel in which an analog signal is sampled at a rate which is less than the channel bit rate.

### BACKGROUND ART

Sampled amplitude read channels have long been employed in communications devices. The term “communications devices” is used herein generically and refers to any device or process in which encoded information is transmitted/received through wired or wireless means. Such devices include, but are not limited to, wireless computer networks and storage channels, such as used in magnetic or optical storage devices. As is well known, information is encoded into a two-level (binary or digital) form which is easy to manipulate, transmit and store. Data is thus stored on magnetic media as flux changes and stored on optical media (such as a CD or DVD) as pits and lands or phase changes in a surface of the media. Data is transmitted wirelessly as changes in electromagnetic radiation.

To read data, a signal which contains the binary data is first received, such as by an RF receiver in a wireless communications environment or by a transducer in a storage environment. The receiver or transducer produce an analog electrical signal in which transitions of the data bits are represented by changes in the electrical waveform. After amplification and other pre-processing, components in the data channel periodically sample the analog waveform; a sequence of samples is processed into a digital data stream of channel bits which are decoded into the original user data bits.

In order to reduce the negative effects of noise, inter-symbol interference and other factors, and to thereby increase the density with which data can be stored and/or the speed at which data can be transmitted, the data may be encoded such that only certain predetermined sequences of transitions in the signal are allowed. A commonly used encoding scheme is a run-length-limited RLL(d,k) code. In such a scheme, there must be at least ‘d’ potential bit transitions between any two actual transitions in the bit stream in order to ensure that two successive transitions are detectable. Additionally, there must be no more than ‘k’ potential bit transitions between any two actual transitions in order to ensure that proper sampling timing may be maintained. Additionally, rather than attempt to detect each individual transition, a sequence detector, such as a Viterbi detector, is commonly used to detect whether, and which, one of the allowed transition sequences is present.

FIG. 1 is a block diagram of a portion of a generic prior art data channel 100. A sampling device 102, such as an analog-to-digital converter (ADC), receives an analog signal 104 from a source 106, such as an RF receiver, a magnetic transducer or an optical pickup. The signal 104 contains encoded digital data in which a peak in the analog waveform during a bit cell period (a sampling window of time during which a transition may occur) represents a digital 1 while the absence of a peak during a bit cell period represents a digital 0. The sampling device 102 samples the analog signal at a rate which is synchronized through a timing recovery component 108 to the baud rate (code bit rate) at which the data was transmitted. The sampling device 102 generates a two-level sample stream at the same code bit rate.

A sampled amplitude sequence detector 110 receives the samples (directly or indirectly) from the sampling device 102. The detector 110, again operating at a channel bit rate which is the same data rate as the sampling device 102, processes the samples and outputs a stream of channel bits 112 which are estimated to be the most likely sequence of the digital data. The channel bits 112 are then decoded by a decoder 114 to regenerate the original user data.

Additional components in the channel 100 typically include a pre-amp 116 to boost the received signal, a variable gain amplifier (“VGA”) 118 to adjust the analog signal's amplitude to a nominal value, a low pass filter (“LPF”) 120 to attenuate noise in the analog signal, an equalizer (“EQ”) 122 to shape the sample values from the sampling device 102 to a predetermined partial response target, and other components, such as a gain control 124 and an equalization (“EQ”) control 126. The details of conventional data encoding, sampling, sequence detection, decoding and error detection are well known.

Components in the prior art data channel 100 all process data at the same rate, the transmission baud rate, and, because the channel bit rate is the same as the transmission baud rate (and sampling rate), one channel bit is output from the detector 110 for each sample processed by the sampling device 102. When the RLL ‘d’ constraint equals 0, the sampling rate is twice highest frequency of the analog waveform and, therefore, conforms to the Nyquist sampling criterion. Even as channels have advanced, however, the sampling rate has continued to equal the bit rate which, for d>0, is greater than the minimum rate to conform to the Nyquist theorem.

Moreover, due to code constraints and pickup limitations of optical pickups, much of the signal energy, and therefore much of the information content, has dissipated at frequencies beyond about one-fourth of the sampling frequency fₛ. FIG. 2 is a plot of the spectral response of prior art optical data (CD, DVD layer 0 and DVD layer 1) relative to the sampling frequency. Due to the attenuations, a practical sampling frequency called for by the Nyquist theorem is effectively fₛ/2. The response of data streams from the two DVD layers falls off by about 40 dB by fₛ/4 while the response of a CD data stream falls off by about 18 dB by fₛ/4. Because the minimum sampling frequency according to the Nyquist theorem is only fₛ/2, it is not necessary to sample at the higher fₛ rate. More importantly, it is wasteful of system resources to sample at such a rate.

### SUMMARY OF THE INVENTION

The present invention provides a data channel in which the sampling rate fₛ is less than the channel bit rate f_{b}. The data channel may be part of an optical storage drive in which data has been RLL encoded at d>0 and the sampling rate may be one-half the channel bit rate. Preferably, a sequence detector is employed which outputs two channel bits for each input sample.

In one embodiment, the data channel comprises a receiver, a sampling device coupled to the output of the receiver and a detector. As used herein, the term “couple” should not be interpreted as being limited only to direct connections between two components, devices or means (generically referred to as “elements”) but may also refer to an indirect relationship in which two elements are separated by one or more intermediary elements such that a path exists between the two elements which includes the intermediary element(s). The receiver processes a binary coded signal having potential transitions occurring at a first frequency and actual successive coded transitions being separated by at least one potential transition. The sampling device outputs digital samples at a second frequency which is less than the first frequency. The detector processes the digital samples and generates channels bits at the first frequency. The binary coded signals may be received from any of a variety of signal sources, such as, but not limited to, an optical disc (such as CD or DVD), magnetic media or a wireless data transmitter.

### BRIEF DESCRIPTION OF THE DRAWINGS

FIG. 1 is a block diagram of a generic prior art data channel;

FIG. 2 is a plot of the spectral response of three types of prior art optical data relative to the sampling frequency;

FIG. 3A is a block diagram of an optical source of a digitally-encoded analog signal which may be input to a read channel of the present invention;

FIG. 3B is a block diagram of a magnetic source of a digitally-encoded analog signal which may be input to a read channel of the present invention;

FIG. 3C is a block diagram of a wireless source of a digitally-encoded analog signal which may be input to a read channel of the present invention;

FIG. 4 is a block diagram of a data channel in which the present invention may be implemented;

FIG. 5 is a plot of the spectral response of three types of optical data according to the present invention;

FIG. 6 is a block diagram of an embodiment of a data channel of the present invention in which signals are processed in parallel;

FIG. 7 is a prior art state diagram of a sequence detector which outputs one channel bit for each input sample; and

FIG. 8 is a state diagram of a sequence detector of the present invention which outputs two channel bits in parallel for each input sample.

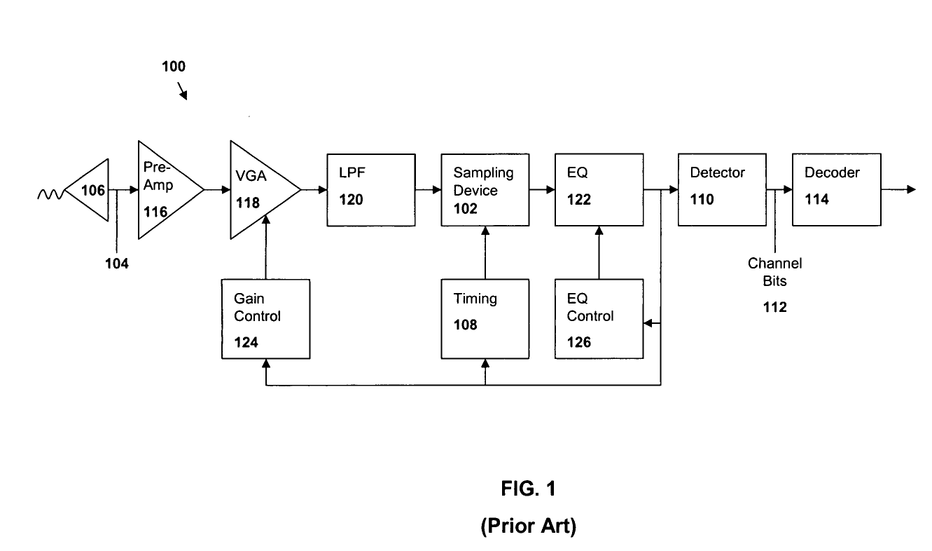

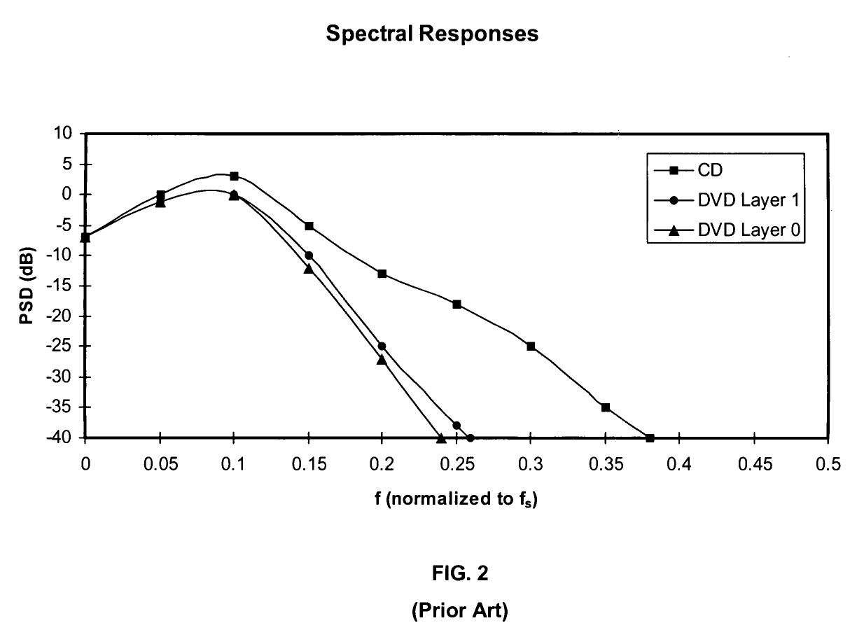

### DETAILED DESCRIPTION OF THE PREFERRED EMBODIMENT

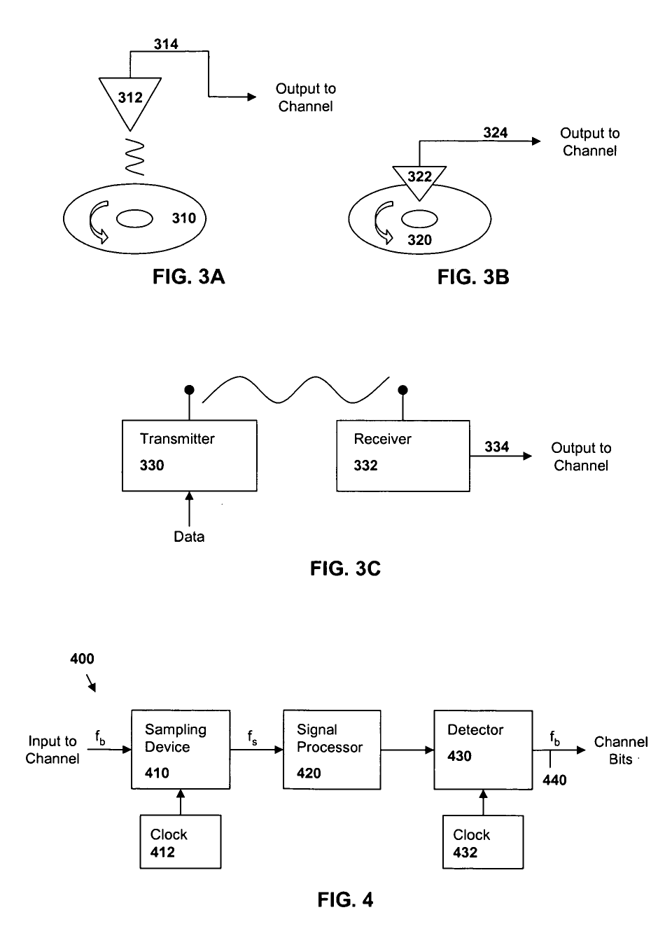

FIGS. 3A, 3B and 3C are block diagrams of exemplary sources of a digitally-encoded analog signal which may be input to a read channel in which the present invention may be implemented. In FIG. 3A, an optical disc 310, such as a CD or a DVD, is encoded with digital user data. A laser and photo sensors in an optical transducer 312 are used to read the data and generate an analog electrical signal 314 representative of the encoded data. Similarly, in FIG. 3B, magnetic media, such as a disk 320, is encoded with digital user data. A magnetic pickup transducer 322 is used to read the data and generate an alalog electrical signal 324 representative of the encoded data. In FIG. 3C, a wireless transmitter 330 transmits digitally encoded user data to a receiver 332 which generates an analog electrical signal 334 representative of the encoded data. The signal sources illustrated in FIGS. 3A-3C are representative of types of signal sources which may be input to a data channel of the present invention; the present invention is not limited to use with these specific sources.

FIG. 4 is a block diagram of a data channel 400 of the present invention to which a signal source, such as those illustrated in FIGS. 3A-3C, transmits binary encoded analog data signals at a predetermined transmission baud rate f_{b}. Thus, state transitions (0 to 1 or 1 to 0) in the data signals have the potential to occur at the baud rate f_{b}. In an optical drive, the baud rate is fixed relative to the spin rate of the disc and the optical data is typically RLL encoded at d>0, such as d=2. Thus, two successive 1's in the unencoded signal, each represented by an actual transition in a bit window, must be separated when encoded by at least two 0's, each a potential transition in a bit window.

The channel 400 includes a sampling device 410 for sampling the input signal and a clock 412 or other means for establishing the rate fₛ at which the input signal is sampled. Any method of retiming or timing recovery may be used with the present invention, such as by varying an ADC clock (such as by using a variable controlled oscillator) or by taking the samples and processing them digitally (such as by using interpolated timing recovery (ITR)). Thus, the functions of the sampling device 410 and clock 412 may be provided by any suitable component or set of components, including a complex digital retiming unit. An optional signal processor 420 may be employed to shape the sample waveform to a desired target waveform. The processor 420 may be an equalizer, ITR (as part of the sampling device 410 and clock 412), equalization with ITR, or some other appropriate device. A detector 430, operating at the rate f_{b} established by a second clock 432 processes the samples and generates a series of channel bits 440. Additional processing (not shown) is then performed on the channel bits 440 to generate data which represents the original user data. It will be appreciated that, for clarity, numerous other processing blocks are not included in FIG. 4.

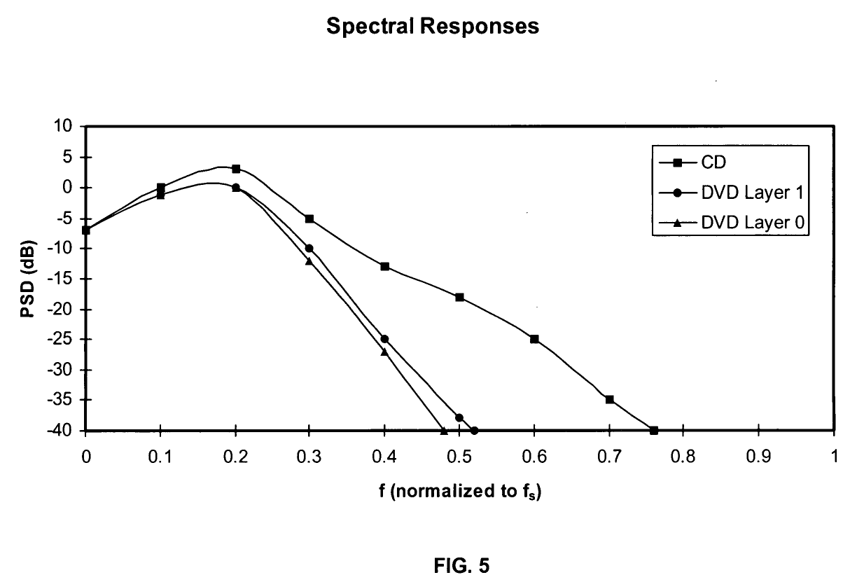

In accordance with the present invention, the sampling rate fₛ is less than the transmitted bit rate f_{b} and, preferably, about one-half the bit rate f_{b} as illustrated in the plots of FIG. 5. As a result, the detector 430 generates two channel bits from each sample received. Moreover, the new sampling rate remains consistent with the Nyquist theorem, thereby preventing significant loss of information. In one embodiment of the present invention, the sampling device 410 may actually sample the incoming signal at the channel bit rate f_{b} but output to the detector 430 only every other sample while ignoring the remaining samples. The effective sampling rate fₛ, that is, the rate at which samples are input to the detector 430, is therefore one-half the channel bit rate f_{b}.

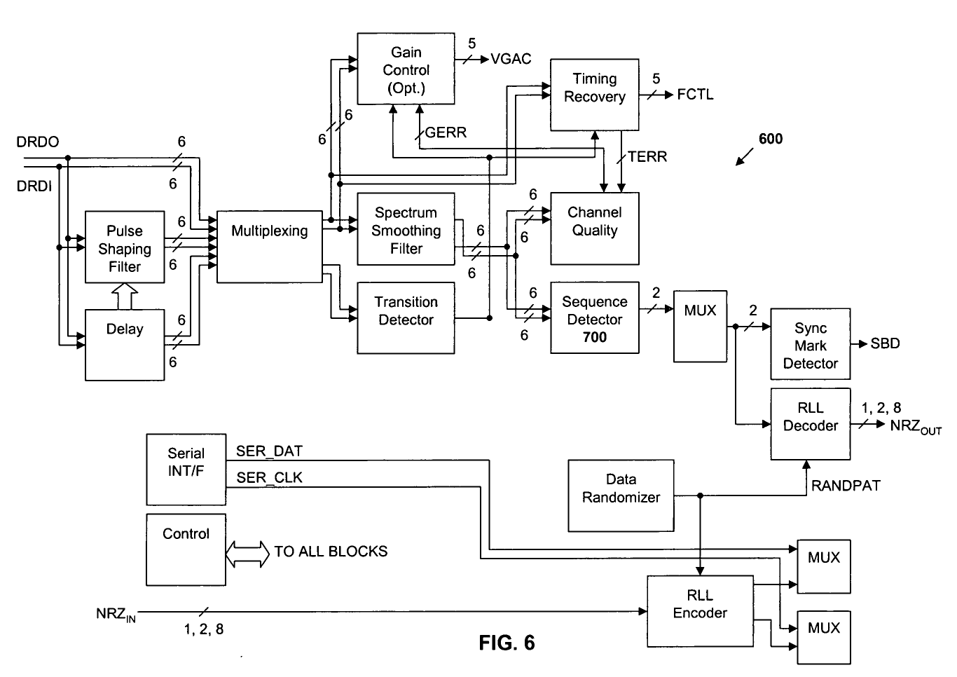

A data channel in which read signals are processed in parallel and in which the present invention may be implemented is described in commonly-assigned U.S. Pat. No. 5,867,331, entitled “Synchronous Read Channel Processing More than One Channel Sample at a Time to Increase Throughput” and incorporated herein by reference in its entirety. FIG. 6 is a block diagram of such a data channel 600 with parallel signals DRD0 and DRD1 representing filtered and digitized data read from storage media. One of the signals, DRD0 is a sample taken at the approximate center of a current channel bit time and DRD1 is a sample taken at the approximate center of the previous channel bit time. In the data channel disclosed in U.S. Pat. No. 5,867,331, two successive channel bits are derived substantially in parallel from the two successive samples. In contrast, in the data channel 600 of the present invention, only one of the two input samples is processed into the two successive channel bits.

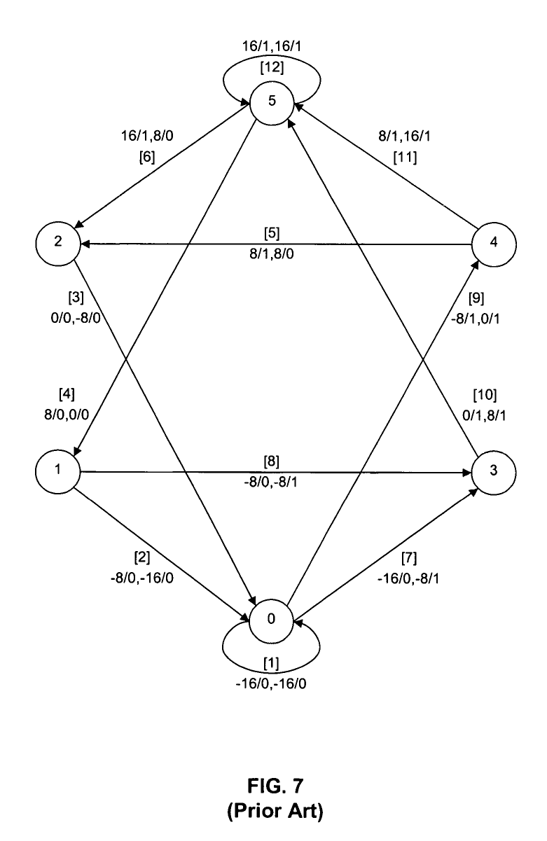

Commonly assigned U.S. Pat. No. 5,291,499, entitled “Method and Apparatus for Reduced-Complexity Viterbi-Type Sequence Detector”, which is also incorporated herein in its entirety, discloses a detector configured to output two channel bits substantially in parallel for each input sample. FIG. 7 is a state diagram of such a sequence detector. The states are identified by state numbers (0-5) within the circles. Branches or paths are annotated with the expected input to cause the corresponding state transition and dual-bit output generated by the transition. Each path is identified by a number in square brackets ([1]-[12]). In FIG. 7, branch metrics are calculated using both of the two possible input samples. The following Table I illustrates the detector outputs for each set of prior paths (PS) and next paths (NP). The input samples are listed in the column labeled dₖ₋₁, dₖ while the last column identifies the two channel bits output from the detector in response to each pair of two input samples.

TABLE I

| Path | PS | NS | dₖ₋₁, dₖ | bₖ₋₁, bₖ |
|---|---|---|---|---|
| 1 | 0 | 0 | −16, −16 | 0, 0 |
| 2 | 1 | 0 | −8, −16 | 0, 0 |
| 3 | 2 | 0 | 0, −8 | 0, 0 |
| 4 | 5 | 1 | 8, 0 | 0, 0 |
| 5 | 4 | 2 | 8, 8 | 1, 0 |
| 6 | 5 | 2 | 16, 8 | 1, 0 |
| 7 | 0 | 3 | −16, 8 | 0, 1 |
| 8 | 1 | 3 | −8, −8 | 1, 1 |
| 9 | 0 | 4 | −8, 0 | 1, 1 |
| 10 | 3 | 5 | 0, 16 | 1, 1 |
| 11 | 4 | 5 | 8, 16 | 1, 1 |
| 12 | 5 | 5 | 16, 16 | 1, 1 |

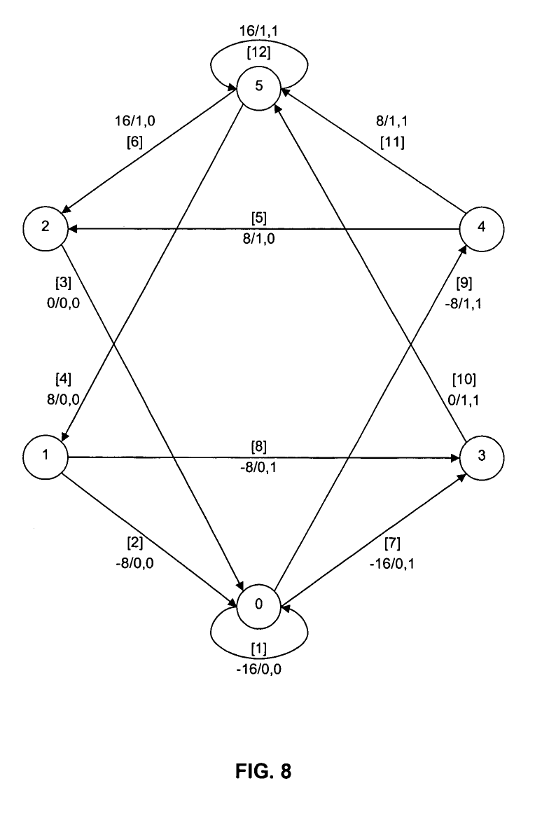

FIG. 8 is a state diagram of such a sequence detector into which the present invention may be incorporated. As in FIG. 7, the states are identified by the state number (0-5) within the circles. Branches or paths are annotated with the expected input to cause the corresponding state transition and dual-bit output generated by the transition. Each path is identified by a number in square brackets ([1]-[12]). The loss of energy in the input signal is significant at frequencies above about fₛ/2 and is, in fact, about 40 dB down at frequencies as low as fₛ/4 for DVD media. Consequently, in contrast to the prior art state diagram of FIG. 7 and the corresponding Table I, branch metrics in FIG. 8 are calculated using only the first of two possible samples (although it will be appreciated that the calculation may be based on the second sample instead). The following Table II illustrates the detector outputs for each set of prior paths (PS) and next paths (NP). The second set of input samples are listed in the third column labeled dₖ₋₁ while the last column lists the two channel bits output from the detector. For each path, there is one pair of output channel bits regardless of whether the prior sample dₖ₋₁ is chosen to be processed or the current sample dₖ is chosen. Selection of the shortest path through the Viterbi trellis may be made in accordance with a known Viterbi algorithm, such as described in the previously referenced U.S. Pat. No. 5,291,499 when configured to process two samples at a time.

TABLE II

| Path | PS | NS | dₖ₋₁ | bₖ₋₁, bₖ |
|---|---|---|---|---|
| 1 | 0 | 0 | −16 | 0, 0 |
| 2 | 1 | 0 | −8 | 0, 0 |
| 3 | 2 | 0 | 0 | 0, 0 |
| 4 | 5 | 1 | 8 | 0, 0 |
| 5 | 4 | 2 | 8 | 1, 0 |
| 6 | 5 | 2 | 16 | 1, 0 |
| 7 | 0 | 3 | −16 | 0, 1 |
| 8 | 1 | 3 | −8 | 1, 1 |
| 9 | 0 | 4 | −8 | 1, 1 |
| 10 | 3 | 5 | 0 | 1, 1 |
| 11 | 4 | 5 | 8 | 1, 1 |
| 12 | 5 | 5 | 16 | 1, 1 |

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims. Moreover, although described above with respect to apparatuses for processing a binary coded signal, the need in the art may also be met by a method for processing a binary coded signal.

What is claimed is:

1. A data channel, comprising:
a receiver for processing a binary coded signal having potential transitions occurring at a first frequency f₁ and actual successive coded transitions being separated by at least one potential transition; and
a detector for processing the digital samples at a second frequency f₂ less than the first frequency f₁ and generating channel bits at the first frequency f₁.

2. The data channel of claim 1, wherein:
f₁ is approximately one-half f₂; and
the detector comprises means for generating two channel bits for each digital sample input from the sampling device.

3. The data channel of claim 1, wherein the receiver comprises means for processing the binary coded signals from an optical disc.

4. The data channel of claim 3, wherein the receiver comprises means for processing the binary coded signals from a DVD.

5. The data channel of claim 3, wherein the receiver comprises means for processing the binary coded signals from a CD.

6. The data channel of claim 1, wherein the receiver comprises means for processing the binary coded signals from magnetic media.

7. The data channel of claim 3, wherein the receiver comprises means for processing the binary coded signals from a wireless data transmitter.

8. The data channel of claim 1, further comprising a processing device coupled between the receiver and the detector.

9. The data channel of claim 8, wherein the processing device comprises an equalizer.

10. The data channel of claim 8, wherein the processing device comprises an interpolated timing recovery device.

11. The data channel of claim 8, wherein the processing device comprises an interpolated timing recovery and equalizer.

12. The data channel of claim 1, further comprising a sampling device coupled to an output of the receiver and operable to output digital samples to the detector at the second frequency f₂.

13. The data channel of claim 12, wherein the sampling device comprises an interpolated timing recovery unit.

14. A sampled-amplitude optical read channel, comprising:
a transducer for receiving a binary coded analog signal from an optical disc, the signal having potential transitions occurring at a first frequency f₁ and actual successive coded transitions being separated by at least one potential transition;
an analog-to-digital converter (ADC) coupled to the transducer for sampling the analog signal and outputting digital samples at a second frequency f₂ less than the first frequency f₁; and
a detector coupled to receive the digital samples from the ADC and generate channel bits at the first frequency f₁.

15. The read channel of claim 14, wherein:
f₁ is approximately one-half f₂; and
the detector comprises means for generating two channel bits for each digital sample input from the ADC.

16. The read channel of claim 14, wherein the transducer comprises means for receiving signals from a DVD.

17. The read channel of claim 14, wherein the transducer comprises means for receiving signals from a CD.

18. The read channel of claim 14, further comprising a processing device coupled between the ADC and the detector.

19. The read channel of claim 18, wherein the processing device comprises an equalizer.

20. The data channel of claim 18, wherein the processing device comprises an interpolated timing recovery device.

21. The data channel of claim 18, wherein the processing device comprises an interpolated timing recovery and equalizer.

22. A method for processing a binary coded analog signal having potential transitions at a first frequency f₁ and actual successive coded transitions being separated by at least one potential transition, comprising:
converting the binary coded signal into digital samples at a second frequency f₂, being less than the first frequency f₁; and
generating channel bits from the digital samples at the first frequency f₁.

23. The method of claim 22, wherein:
f₁ is approximately one-half f₂; and
generating channel bits comprises generating two channel bits for each digital sample input from the sampling device.

24. The method of claim 22, wherein the binary coded signals are received from an optical disc.

25. The method of claim 24, wherein the binary coded signals are received from a DVD.

26. The method of claim 24, wherein the binary coded signals are received from a CD.

27. The data channel of claim 24, wherein the receiver comprises means for processing the binary coded signals from magnetic media.

28. The method of claim 24, wherein the binary coded signals are received from a wireless data transmitter.

29. A sampled-amplitude optical read channel, comprising:
a transducer for processing a binary coded analog signal from an optical disc, the signal having potential transitions at a first frequency f₁ and actual successive coded transitions being separated by at least one potential transition; and
an analog-to-digital converter (ADC) coupled to the transducer for sampling the analog signal and outputting digital samples at a second frequency f₂ less than the first frequency f₁.

30. The optical read channel of claim 29, further comprising a detector coupled to the output of the ADC for generating channel bits at the first frequency f₁.

31. The optical read channel of claim 29, wherein the transducer comprises means for processing the binary coded signals from a DVD.

32. The optical read channel of claim 29, wherein the transducer comprises means for processing the binary coded signals from a CD.
